(19) United States
(12) Patent Application Publication
(10) Pub. No.: US 2017/0101059 A1
(43) Pub. Date: Apr. 13, 2017

(54) VEHICLE DISPLAY MIRROR ASSEMBLY HAVING IMPROVED EFFICIENCY

(71) Applicant: Gentex Corporation, Zeeland, MI (US)

(72) Inventors: Andrew D. Weller, Holland, MI (US); Gary J. Dozeman, Zeeland, MI (US)

(21) Appl. No.: 15/291,237

(22) Filed: Oct. 12, 2016

Related U.S. Application Data
(60) Provisional application No. 62/240,634, filed on Oct. 13, 2015.

(51) Int. Cl. B60R 1/12; B60R 1/04

(52) U.S. Cl. CPC B60R 1/12; B60R 1/04; B60R 2001/1215; B60R 1/088

(57) ABSTRACT

A display mirror assembly for a vehicle includes a mirror element having a front surface and a rear surface, wherein the mirror element has a refractive index R_{M} at the rear surface of the mirror element; a display having a front surface and a rear surface where the display is positioned behind the mirror element such that the front surface of the display is spaced apart from the rear surface of the mirror element, wherein the display has a refractive index R_{D} at the rear surface of the display; and an optical bonding layer disposed between, and in contact with, the front surface of the display and the rear surface of the mirror element, for bonding the mirror element to the display. The optical bonding layer has a refractive index refractive index of R_{O} between about ±10% R_{D} and ±10% R_{M}.

### CROSS-REFERENCE TO RELATED APPLICATION

This application claims priority to and the benefit under 35 U.S.C. §119(e) of U.S. Provisional Patent Application No. 62/240,634, filed on Oct. 13, 2015, entitled “VEHICLE DISPLAY MIRROR ASSEMBLY HAVING IMPROVED EFFICIENCY,” the entire disclosure of which is hereby incorporated herein by reference.

### FIELD OF THE INVENTION

The present invention generally relates to a display mirror assembly for a vehicle.

### BACKGROUND OF THE INVENTION

As shown in FIG. 5, current vehicle display mirror assemblies 100 include a display 118 attached to the rear surface of a rearmost substrate 111 of a mirror element 112 in spaced relation with an air gap 115 provided therebetween. Mirror element 112 may also include a front substrate 113. The air gap 115 provides for tolerance of manufacturing variances that may result in either the rear surface of mirror element 112 or the front surface of display 118 from not being completely smooth and flat. The display 118 is secured within a shield 119 that is bonded to the rear surface of rearmost substrate 111 by an elastomer boot 121. Examples of a display mirror are described in U.S. Pat. No. 8,879,139 and U.S. Patent Application Publication No. US 2014/0268351 A1.

### SUMMARY OF THE INVENTION

According to one aspect of the present invention, a display mirror assembly for a vehicle is provided comprising a mirror element having a front surface and a rear surface, wherein the mirror element has a refractive index R_{M} at the rear surface of the mirror element; a display having a front surface and a rear surface where the display is positioned behind the mirror element such that the front surface of the display is spaced apart from the rear surface of the mirror element, wherein the display has a refractive index R_{D} at the front surface of the display; and an optical medium disposed between, and in contact with, the front surface of the display and the rear surface of the mirror element, the optical medium having a refractive index of R_{O} between about ±10% R_{D} and ±10% R_{M}.

According to another aspect of the present invention, a display mirror assembly for a vehicle is provided comprising a mirror element having a front surface and a rear surface, wherein the mirror element has a refractive index R_{M} at the rear surface of the mirror element; a display having a front surface and a rear surface where the display is positioned behind the mirror element such that the front surface of the display is spaced apart from the rear surface of the mirror element, wherein the display has a refractive index R_{D} at the front surface of the display; and an optical bonding layer disposed between, and in contact with, the front surface of the display and the rear surface of the mirror element, for bonding the mirror element to the display. The optical bonding layer has a refractive index of R_{O} between about ±10% R_{D} and ±10% R_{M}.

According to another aspect of the present invention, a method of making a display mirror assembly is provided where the method comprises: providing a mirror element having a rear surface; providing a display having a front surface; and bonding the front surface of the display to the rear surface of the mirror element using an optical bonding layer disposed between, and in contact with, the front surface of the display and the rear surface of the mirror element, wherein the mirror element has a refractive index R_{M} at the rear surface of the mirror element, the display having a refractive index R_{D} at the front surface of the display, and the optical bonding layer having a refractive index of R_{O} between about ±10% R_{D} and ±10% R_{M}.

These and other features, advantages, and objects of the present invention will be further understood and appreciated by those skilled in the art by reference to the following specification, claims, and appended drawings.

### BRIEF DESCRIPTION OF THE DRAWINGS

The present invention will become more fully understood from the detailed description and the accompanying drawings, wherein:

FIG. 1 is a top front perspective view of a display mirror assembly for a vehicle, in accordance with one embodiment of the present invention;

FIG. 2 is a bottom front perspective view of the display mirror assembly of FIG. 1;

FIG. 3 is a side elevation view of the display mirror assembly of FIG. 1;

FIG. 4 is a top view of the display and mirror element of the display mirror assembly of FIG. 1; and

FIG. 5 is a top view of a display and mirror element of a display mirror assembly according to past practices.

### DETAILED DESCRIPTION OF THE EMBODIMENTS

The present illustrated embodiments reside primarily in combinations of method steps and apparatus components related to a display mirror assembly, particularly one adapted for use as a vehicle rearview assembly. Accordingly, the apparatus components and method steps have been represented, where appropriate, by conventional symbols in the drawings, showing only those specific details that are pertinent to understanding the embodiments of the present invention so as not to obscure the disclosure with details that will be readily apparent to those of ordinary skill in the art having the benefit of the description herein. Further, like numerals in the description and drawings represent like elements.

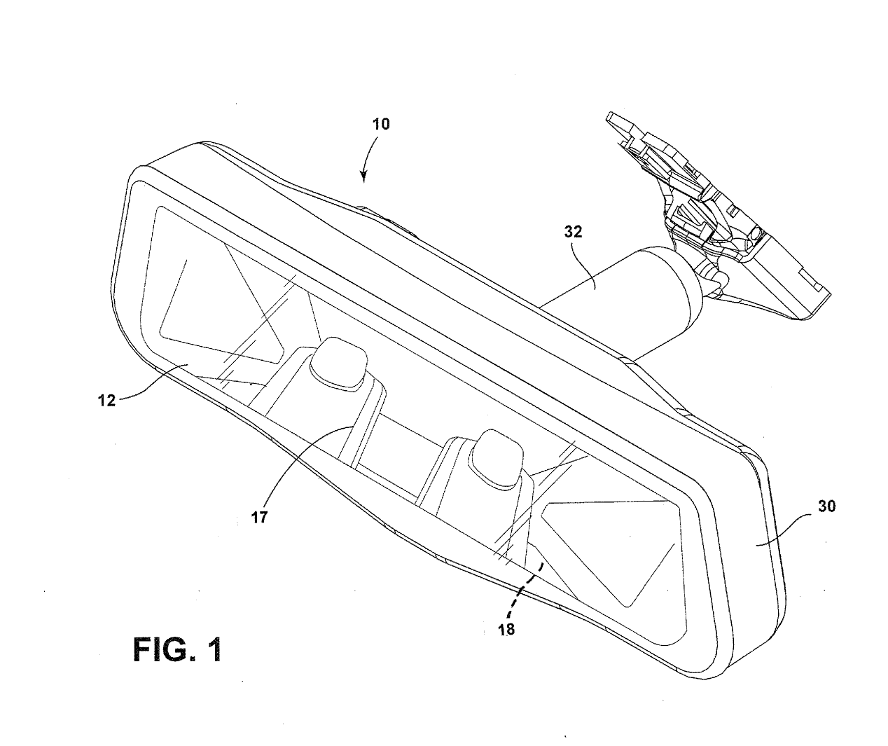

For purposes of description herein, the terms “upper,” “lower,” “right,” “left,” “rear,” “front,” “vertical,” “horizontal,” and derivatives thereof shall relate to the invention as oriented in FIG. 1. Unless stated otherwise, the term “front” shall refer to the surface of the element closer to an intended viewer of the rearview assembly, and the term “rear” shall refer to the surface of the element further from the intended viewer of the rearview assembly. However, it is to be understood that the invention may assume various alternative orientations, except where expressly specified to the contrary. It is also to be understood that the specific devices and processes illustrated in the attached drawings and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The terms “including,” “comprises,” “comprising,” or any other variation thereof, are intended to cover a non-exclusive inclusion, such that a process, method, article, or apparatus that comprises a list of elements does not include only those elements, but may include other elements not expressly listed or inherent to such process, method, article, or apparatus. An element preceded by “comprises . . . a” does not, without more constraints, preclude the existence of additional identical elements in the process, method, article, or apparatus that comprises the element.

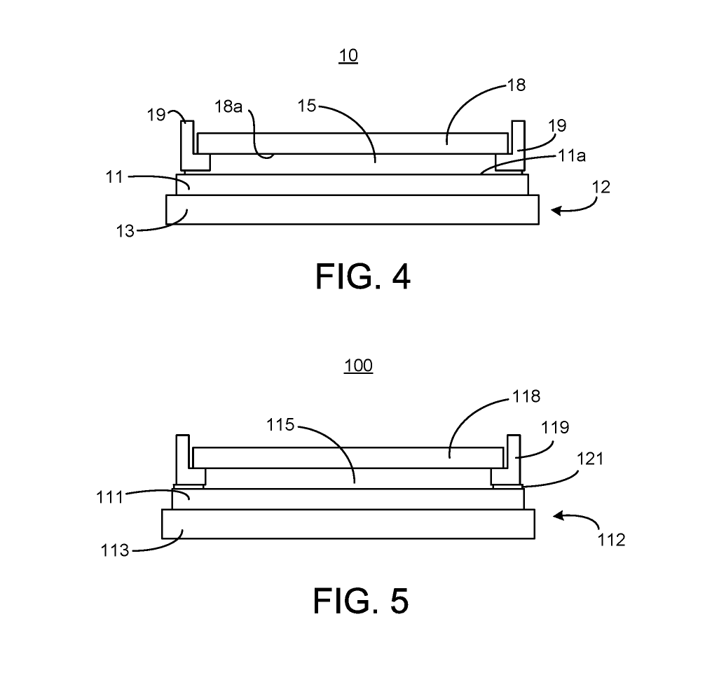

Referring now to the drawings, reference numeral 10 generally designates a display mirror assembly for a vehicle. As shown in FIG. 4, the display mirror assembly 10 includes a mirror element 12, which may have a partially reflective, partially transmissive coating or layer provided on a rear surface 11a of a rearmost substrate 11 of mirror element 12, and a display 18 that is viewed through the mirror element 12. Unlike prior display mirror assemblies, display mirror assembly 10 includes an optical bonding material disposed between display 18 and mirror element 12 to form an optical bonding layer 15. As discussed further below, optical bonding layer 15 provides two primary functions, namely, bonding the display 18 to mirror element 12 and reducing internal reflections by matching the indices of refraction of display 18 and mirror element 12.

Optical bonding layer 15 may be formed of a material that has a refractive index that is substantially the same as that of one or both of rear substrate 11 of mirror element 12 and display 18 and a polarizer that may be disposed on the forward most surface of display 18. In general, the refractive index of optical bonding layer 15 should be within 10% of that of the display 18 and mirror element 12 to keep reflectance within 0.5% or less at the surface interfaces. In other words, where the mirror element 12 has a refractive index R_{M} at the rear surface 11a of the mirror element 12 and the display 18 has a refractive index R_{D} at the front surface 18a of the display 18, the optical bonding layer 15 has a refractive index of R_{O} between about ±10% R_{O} and ±10% R_{M}. The closer the refractive index is the better. In prior constructions as shown in FIG. 5, the air within air gap 115 has a refractive index of about 1, which results in a reflectance of about 4% at each surface adjacent air gap 115. By using an optical bonding layer 15 (FIG. 4) with a refractive index that is substantially the same as that of rear substrate 11 or front of display 18, reflectance between internal assembly surfaces is reduced leading to increased transmission, higher light output/lighting efficiency, and increased display image clarity/quality by eliminating reflectance “noise” factor. A reflectance of about 0.25% at each surface adjacent optical bonding layer 15 can be expected when using an optical bonding material with a refractive index of 1.48 when the display has a refractive index of 1.52 and the mirror element has a refractive index of 1.53. When the refractive index of display 18 and the polarizer are about 1.52 and the refractive index of rear substrate 11 of mirror element 12 is about 1.53, optical bonding layer 15 may have a refractive index of 1.37 to 1.68.

As noted above, optical bonding layer 15 also serves to bond the mirror element 12 to the display 18. The large surface area over which optical bonding layer 15 forms this bond provides a much more rigid bond than prior designs. In fact, it is believed that by supporting display 18 within the mirror housing 30 (FIGS. 1-3), the need for any additional support of mirror element 12 may be reduced or eliminated. In prior designs, a bezel or frame was needed to support the mirror element. By eliminating the need for support from the bezel or frame, a frameless display mirror assembly may be constructed. Further, because of the increased bonding strength of optical bonding layer 15, the individual glass elements (mirror and display) become or act like a single stronger/more rigid glass assembly when bonded together. Therefore, it may be possible to use one or more thinner glass substrates thereby reducing the weight of the mirror element 12, which correspondingly reduces unwanted vibration. In addition, the optical bonding layer 15 may extend between the rear surface 11a of the mirror element and a shield 19 so as to secure the shield 19 without the need for a separate elastomeric boot.

Use of optical bonding layer 15 further provides greater electrical efficiency since greater optical transmission through mirror element 15 means that the backlight of display 18 does not need to be driven as hard to produce a given brightness level through the mirror element. Thus, less electrical power is needed to obtain the same optical performance levels.

Also, the visual appearance of the display mirror assembly is improved at night by using optical bonding layer 15. Previously, the polarizer material used in the current display has an anti-glare coating that has a haze that scrambles the reflected image. In the absence of such an anti-glare coating, the display otherwise has to be perfectly parallel to the rear surface of the mirror element, and even then there still might be a concern with double imaging. When optical bonding layer 15 is used to reduce reflection from display 18, the anti-glare coating is not needed on the polarizer. Elimination of the anti-glare coating improves the appearance of the display mirror assembly at night. Further, the anti-glare coating also reduces transmission so elimination of this coating further increases transmission.

The optical bonding layer 15 between the display 18 and mirror element 12 can be made with a variety of materials. The primary characteristics are transparency, suitable refractive index, bonding strength, and durability to moisture and temperature extremes. Optically clear adhesives are available in liquid and film form. Liquid optically clear adhesives (LOCAs) are available in a wide range of chemistries, viscosities, and curing mechanisms. LOCAs are typically 100% solid formulations based on silicone, epoxy, acrylic, or acrylated urethane chemistries and are available in a wide range of viscosities to meet application requirements. Higher viscosity formulations are often used as a dam to control the placement of lower viscosity fill formulations, which easily conform to the display and mirror element substrates. LOCAs are usually precisely pressure dispensed, but other methods such as slot die coating could also be employed. The LOCAs can be cured thermally, with ultraviolet (UV) light, and UV/moisture dual cure mechanisms. Examples of suitable LOCAs include the DELO-PHOTOBOND® and DELO-DUALBOND® series available from DELO Industrial Adhesives (Windach, Germany). Other examples of suitable LOCAs include Loctite 3196 and Loctite 5192 available from Henkel AG and Co. (Dusseldorf, Germany) and the 9700-Series available from Dymax Corporation (Torrington, Conn.). Similar materials are available from other suppliers. An advantage to using a wet process to form optical bonding layer 15 is that it can accommodate more tolerance for a lack of flatness of mirror element 12 and display 18. Optically clear adhesives (OCAs) in film form, also known as optically clear film adhesives, optically clear pressure sensitive adhesives, or optical interlayers, are available in a variety of chemistries and are typically used in lamination processes using heat, vacuum, and pressure to bond the substrates. The film forms are based on acrylic, aliphatic thermoplastic urethanes (TPU), ethylene vinyl acetate (EVA), ionoplast, or polyvinyl butyral (PVB) chemistries. Examples of suitable film-based optically clear adhesives are OCA 8142 and OCA 9483 available from 3M (St. Paul, Minn.). Similar materials are available from other suppliers. Optical bonding services using film-based optically clear pressure sensitive adhesives are available for display to mirror element bonding through Rockwell Collins (Cedar Rapids, Iowa). Other companies offer similar bonding services.

As shown in FIGS. 1-3, the display mirror assembly 10 includes a housing 30 that at least partially receives the mirror element 12 (and the display 18), and includes a mounting member 32 extending rearwardly therefrom. The mounting member 32 is adapted for mounting on a windshield or header of a vehicle. The mounting member 32 may be operably engaged with the housing 30 in any known manner.

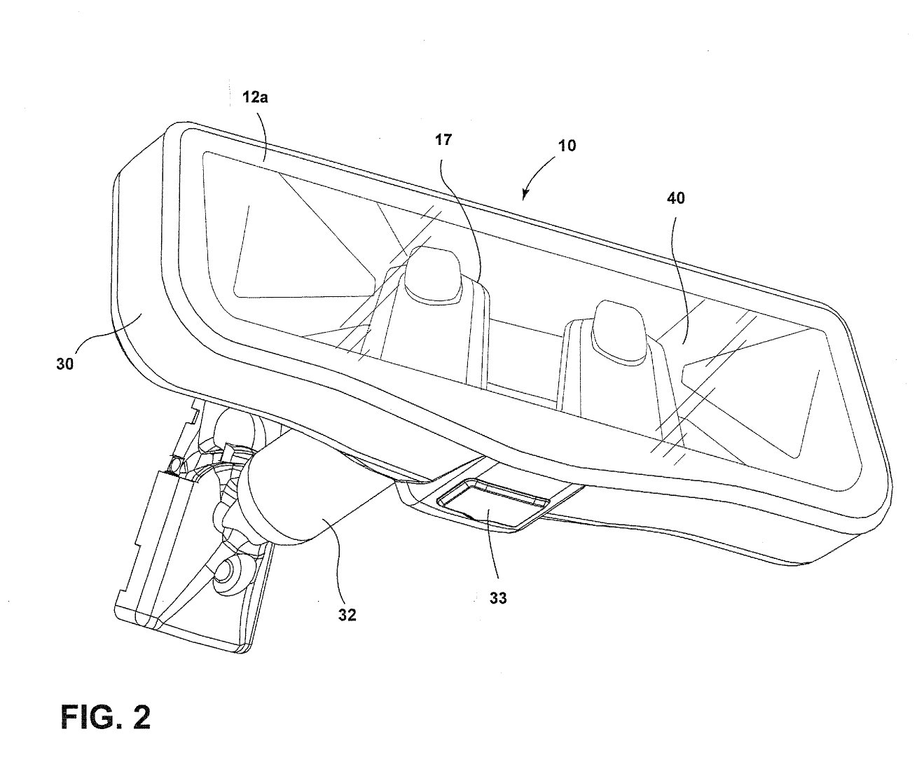

Referring generally to FIG. 2, the display mirror assembly 10 has a viewing area 40, which includes a front surface 12a of the mirror element 12. The viewing area 40 may be a rectangular shape, a trapezoidal shape, or any custom contoured shape desired for aesthetic reasons. The perimeter of the mirror element 12 may also have a ground edge, a beveled edge, or be frameless.

The display 18 may be generally planar, with outer edges defining a front surface. The front surface of the display 18 can be shaped to correspond to and fit within the shape of the viewing area 40 of the display mirror assembly 10. As illustrated in FIG. 1, the display 18 can have a trapezoidal shape. However, it should be appreciated by those skilled in the art that the display 18 can have other shapes, such as, but not limited to, square, rectangular, symmetrical, non-symmetrical, or contoured. The display 18 may have a front surface which fits within, but is not complementary to the viewing area 40, for example, where the front surface of the display 18 is generally rectangular and the front surface 12a of the mirror element 12 has a contoured outer perimeter. The distance between the outer edges of the display 18 and the outer perimeter of the mirror element 12 may be about 9 mm or less along at least a portion of the outer edges of display 18. The display 18 may be a liquid crystal display (LCD), LED, OLED, plasma, DLP or other display technology. Various types of LCDs can be used, including, but not limited to, twisted nematic (TN), in-plane switching (IPS), fringe field switching (FFS), vertically aligned (VA), etc.

By way of explanation and not limitation, in operation, the display mirror assembly 10 can be used as a full display mirror in a vehicle to be operational substantially continuously while driving, as opposed to back-up display systems that are used only during certain times of vehicle operation (i.e., when the vehicle is in reverse gear).

Although mirror element 12 is shown in FIG. 4 as having two substrates 11 and 13 of an electro-optic mirror element, such as an electrochromic mirror element, mirror element 12 may also be a prismatic mirror element.

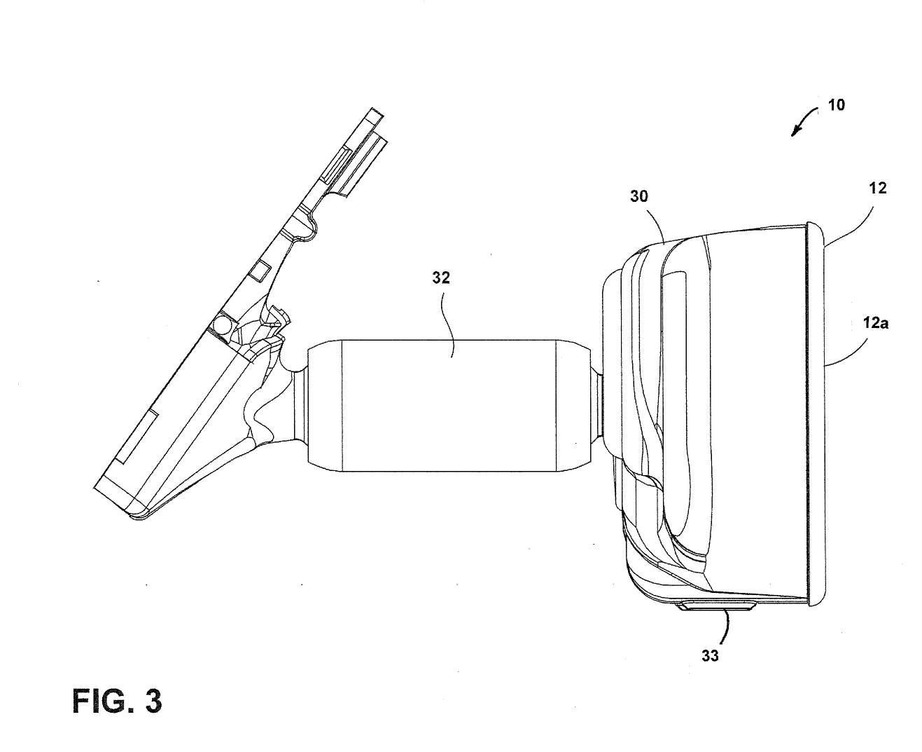

Display mirror assembly 10 may optionally include an actuator device 33, as shown in FIGS. 2 and 3. When actuated, the actuator device 33 moves at least the mirror element 12 from a first viewing position. The actuator device 33 may also move the whole housing 30. Actuation of the actuator device 33 tilts or rotates the mirror element 12 upwards to move the mirror element 12 to one of two or three viewing positions. The actuator device 33 can also be configured to move the display 18 upon activation. For example, if mirror element 12 is a prismatic element, when in the second viewing position, the mirror element 12 is positioned to reflect a secondary reflected image towards the viewer's eyes while the primary reflected image is reflected upward away from the viewer's eyes. This allows the driver to only see the lower intensity secondary reflected image during nighttime driving so that headlights from a trailing vehicle are less likely to produce a distracting glare. In other words, the driver instead sees reflections from the front surface of mirror element 12, which are much lower in intensity. Display 18 may be automatically activated when actuator device 33 moves mirror element 12 to the second viewing position.

Additionally, to provide information to the viewer of the display mirror assembly 10, the display mirror assembly 10 may include information regarding the field of view 17, such as a partially transmissive graphic overlay or an image on the display 18 visible on the viewing area 40 when the display 18 is in use.

The above description is considered that of the preferred embodiments only.

Modifications of the invention will occur to those skilled in the art and to those who make or use the invention. Therefore, it is understood that the embodiments shown in the drawings and described above are merely for illustrative purposes and not intended to limit the scope of the invention, which is defined by the claims as interpreted according to the principles of patent law, including the doctrine of equivalents.

What is claimed is:

1. A display mirror assembly for a vehicle, comprising:
a mirror element having a front surface and a rear surface, wherein the mirror element has a refractive index R_{M} at the rear surface of the mirror element;
a display having a front surface where the display is positioned behind the mirror element such that the front surface of the display is spaced apart from the rear surface of the mirror element, wherein the display has a refractive index R_{D} at the front surface of the display; and
an optical medium disposed between, and in contact with, the front surface of the display and the rear surface of the mirror element, the optical medium having a refractive index of R_{O} between about ±10% R_{D} and ±10% R_{M}.

2. The display mirror assembly of claim 1, wherein the optical medium forms an optical bonding layer that bonds the display and the mirror element to one another.

3. The display mirror assembly of claim 2 and further including a shield positioned around a periphery of the display, the optical bonding layer extends between the mirror element and the shield to bond the shield to the mirror element.

4. The display mirror assembly of claim 2, wherein the optical bonding layer extends across and contacts substantially the entire front surface of the display.

5. The display mirror assembly of claim 4, wherein the optical bonding layer extends across and contacts substantially the entire portion of the rear surface of the mirror element that is juxtaposed the front surface of the display.

6. The display mirror assembly of claim 1, wherein the optical medium has a refractive index of R_{O} between 1.37 and 1.68.

7. The display mirror assembly of claim 1, wherein the optical medium is a liquid optically clear adhesive.

8. The display mirror assembly of claim 7, wherein the liquid optically clear adhesive is selected from the group consisting of silicone, epoxy, acrylic, and acrylated urethane.

9. The display mirror assembly of claim 1, wherein the optical medium is an optically clear film adhesive selected from the group consisting of acrylic, aliphatic thermoplastic urethanes, ethylene vinyl acetate, ionoplast, and polyvinyl butyral.

10. A display mirror assembly for a vehicle, comprising:
a mirror element having a front surface and a rear surface, wherein the mirror element has a refractive index R_{M} at the rear surface of the mirror element;
a display having a front surface where the display is positioned behind the mirror element such that the front surface of the display is spaced apart from the rear surface of the mirror element, wherein the display has a refractive index R_{D} at the front surface of the display; and
an optical bonding layer disposed between, and in contact with, the front surface of the display and the rear surface of the mirror element, for bonding the mirror element to the display.

11. The display mirror assembly of claim 10, wherein the optical bonding layer has a refractive index of R_{O} between about ±10% R_{D} and ±10% R_{M}.

12. The display mirror assembly of claim 10 and further including a shield positioned around a periphery of the display, the optical bonding layer extends between the mirror element and the shield to bond the shield to the mirror element.

13. The display mirror assembly of claim 10, wherein the optical bonding layer extends across and contacts substantially the entire front surface of the display.

14. The display mirror assembly of claim 13, wherein the optical bonding layer extends across and contacts substantially the entire portion of the rear surface of the mirror element that is juxtaposed the front surface of the display.

15. The display mirror assembly of claim 10, wherein the optical bonding layer has a refractive index of R_{O} between 1.37 and 1.68.

16. The display mirror assembly of claim 10, wherein the optical bonding layer is made from a liquid optically clear adhesive.

17. The display mirror assembly of claim 16, wherein the liquid optically clear adhesive is selected from the group consisting of silicone, epoxy, acrylic, and acrylated urethane.

18. The display mirror assembly of claim 10, wherein the optical bonding layer is made from an optically clear film adhesive selected from the group consisting of acrylic, aliphatic thermoplastic urethanes, ethylene vinyl acetate, ionoplast, and polyvinyl butyral.

19. A method of making a display mirror assembly comprising:
providing a mirror element having a rear surface;
providing a display having a front surface; and
bonding the front surface of the display to the rear surface of the mirror element using an optical bonding layer disposed between, and in contact with, the front surface of the display and the rear surface of the mirror element,
wherein the mirror element has a refractive index R_{M} at the rear surface of the mirror element, the display has a refractive index R_{D} at the front surface of the display, and the optical bonding layer having a refractive index of R_{O} between about ±10% R_{D} and ±10% R_{M}.

20. The method of claim 19, wherein the optical bonding layer has a refractive index of Rₒ between 1.37 and 1.68.
